(19) United States
(12) Patent Application Publication
(10) Pub. No.: US 2007/0264447 A1
(43) Pub. Date: Nov. 15, 2007

(54) Optical Film Laminated Body

(75) Inventors: Taro Oya, Gifu (JP); Mitsumasa Ono, Gifu (JP)

Correspondence Address: SUGHRUE MION, PLLC, 2100 PENNSYLVANIA AVENUE, N.W., SUITE 800, WASHINGTON, DC, 20037, US

(73) Assignee: Teijin DuPont Films Japan Limited, Tokyo (JP)

(21) Appl. No.: 11/661,279

(22) PCT Filed: Aug. 29, 2005
(86) PCT No.: PCT/JP05/16165

§ 371 Date: Feb. 27, 2007

(30) Foreign Application Priority Data
Aug. 30, 2004 (JP) 2004-249740
Feb. 2, 2005 (JP) 2005-026383

(51) Int. Cl. C09K 19/00; B32B 27/06; B32B 9/00; B32B 9/04

(52) U.S. Cl. 428/1.31; 428/411.1; 428/430; 428/480

(57) ABSTRACT

According to an optical film laminated body containing a reflective polarizing film having a water vapor transmittance of from 5 to 20 g/m²/day, an absorptive polarizing film and a transparent film having a water vapor transmittance of from 100 to 500 g/m²/day, in this order, characterized in that a transmission axis of the reflective polarizing film is in parallel to a transmission axis of the absorptive polarizing film, sufficient adhesion property between the reflective polarizing film and the absorptive polarizing film can be obtained, so as to provide an optical film laminated body causing no warpage.

### TECHNICAL FIELD

The present invention relates to an optical film laminated body, and to an optical film laminated body used for a display device, such as a liquid crystal display device.

### BACKGROUND ART

An optical film laminated body containing an absorptive polarizing film as a constitutional component is used as a member of a liquid crystal display device. In recent years, an optical film laminated body is demanded to have high performance, and for example, demanded to have a function for improving display quality, such as color tone, luminance, contrast and large viewing angle.

Among the display quality of a liquid crystal display device, luminance is particularly important. A reflective polarizing film and an absorptive polarizing film are being used in combination for obtaining a high luminance. In a liquid crystal display device, in general, a reflective polarizing film is disposed between a backlight unit and an absorptive polarizing film. The reflective polarizing film improves the luminance of the display screen by utilizing light that is absorbed unless the reflective polarizing film is provided.

The reflective polarizing film separates light into two components, i.e., P polarized light and S polarized light, and transmits any one of the polarized light components. The polarized light component having been transmitted is fed to the absorptive polarizing film. On the other hand, the polarizing light component reflected by the reflective polarizing film is fed to a reflector plate and scattered by the reflector plate thereby becoming light containing P polarized light and S polarized light, which is fed again to the reflective polarizing film. The light is again separated into P polarized light and S polarized light.

A multilayer laminated film formed of plastics has been known. The multilayer laminated film contains a large number of plastic layers having a low refractive index and plastic layers having a high refractive index laminated alternately, and selectively reflects or transmits light having a particular wavelength through optical interference caused by the structure of the layers. The multilayer laminated film is also used as a reflective polarizing film by utilizing the capability. In general, such a multilayer laminated film exhibits an enhanced reflection phenomenon that contains a large number of two kinds of layers different in refractive index laminated alternately and has a thickness of the layers of from 0.05 to 0.5 μm. The phenomenon is that light having a particular wavelength is selectively reflected. The wavelength that is selectively reflected is generally shown by the following expression:
λ=2×((n1)×(d1)+(n2)×(d2))

In the expression λ represents the wavelength (nm) that is selectively reflected, n1 represents the refractive index of one layer, d1 represents the thickness (nm) of the layer, n2 represents the refractive index of the other layer, and d2 represents the thickness (nm) of the layer.

A reflective polarizing film that reflects P polarized light and transmits S polarized light can be designed by utilizing the principle. The preferred birefringence of a multilayer laminated film constituted by the one layer and the other layer is shown by the following expression:
n1x>n2x,n1y=n2y

In the expression, nix represents the refractive index of the one layer in the stretching direction, n1y represents the refractive index of the layer in the direction perpendicular to the stretching direction, n2x represents the refractive index of the other layer in the stretching direction, and n2y represents the refractive index of the layer in the direction perpendicular to the stretching direction.

Such uniaxially stretched multilayer laminated films have been known that contain polyethylene-2,6-naphthalene dicarboxylate as the layer having a high refractive index and a thermoplastic elastomer as the layer having a low refractive index, and contain polyethylene-2,6-naphthalene dicarboxylate as the layer having a high refractive index and polyethylene-2,6-naphthalene dicarboxylate copolymerized with 30% by mol of isophthalic acid as the layer having a low refractive index (as described in JP-A-9-506837 and WO 01/47711).

These are reflective polarizing films that reflect only particular polarized light by using a polymer having a positive stress-optical coefficient as one layer and a polymer having a considerably small stress-optical coefficient (i.e., exhibiting extremely small birefringence through stretching) as the other layer. However, the reflective polarizing films have a large thickness of about 135 μm and low water vapor permeation characteristics, and thus it is difficult to use by adhering with an absorptive polarizing film.

On the other hand, as an absorptive polarizing film, such a film is used that is obtained by adsorbing iodine on a polyvinyl alcohol (hereinafter, sometimes referred to as PVA) film, which is then stretched. The absorptive polarizing film is generally used as a laminated body formed by laminating transparent films on both surfaces thereof for preventing the film from being scratched in the process. As the transparent film, a triacetyl cellulose (hereinafter, sometimes referred to as TAC) film is generally used.

### DISCLOSURE OF THE INVENTION

Instead of the case where a TAC film is laminated on one surface of an absorptive polarizing film, and a reflective polarizing film is disposed thereon, a reflective polarizing film may be laminated on an absorptive polarizing film, whereby interface reflection between the TAC film and the air layer, and interface reflection between the reflective polarizing film and the air layer can be suppressed, so as to obtain a high luminance. In other words, such an optical film laminated body is used that is obtained by laminating a reflective polarizing film and an absorptive polarizing film, whereby such an optical film laminated body can be obtained that attains a high luminance upon using in a liquid crystal display device. However, an absorptive polarizing film is liable to absorb moisture owing to the hydrophilicity thereof, and moisture is not sufficiently evaporated upon adhering to a reflective polarizing film. Accordingly, the adhesion property at the adhesion interface becomes short to cause warpage after adhesion.

An object of the invention is to solve the aforementioned problems. That is, the invention is to provide such an optical film laminated body that is an optical film laminated body having an absorptive polarizing film on one surface of a reflective polarizing film, but provides high adhesion property between the reflective polarizing film and the absorptive polarizing film, causes no appearance failure due to warpage or interlayer detachment, and has high durability upon long-term use.

The invention is also to provide such a novel optical film laminated body that is constituted by a smaller number of constitutional members than conventional products, and is excellent in productivity.

The invention relates to an optical film laminated body containing a reflective polarizing film, an absorptive polarizing film and a transparent film in this order, characterized in that a transmission axis of the reflective polarizing film is in parallel to a transmission axis of the absorptive polarizing film, the reflective polarizing film has a water vapor transmittance of from 5 to 20 g/m²/day, and the transparent film has a water vapor transmittance of from 100 to 500 g/m²/day.

The optical film laminated body of the invention has such a constitution that a reflective polarizing film is provided on one surface of an absorptive polarizing film, and a transparent film is provided on the other surface thereof. FIG. 1 shows an example of a representative constitution of the optical film laminated body of the invention.

In the optical film laminated body of the invention, the transmission axes of the absorptive polarizing film and the reflective polarizing film are in parallel to each other. The term “parallel” referred herein means that an angle between the axes is preferably from 0 to 5°, and more preferably from 0 to 30°.

### BRIEF DESCRIPTION OF THE DRAWINGS

FIG. 1 is a cross sectional view showing an example of an embodiment of the optical film laminated body of the invention.

FIG. 2 is a cross sectional view showing an example of a constitution of the optical film laminated body of the invention, where an optical compensation retardation film is used as the transparent film.

FIG. 3 is an example of a reflectance curve of a reflective polarizing film in the invention. P polarized light is a polarized light component that is in parallel to a plane containing both the stretching direction of the film and the direction perpendicular to the film surface, and S polarized light is a polarized light component that is perpendicular to a plane containing both the stretching direction of the film and the direction perpendicular to the film surface.

FIG. 4 is a cross sectional view showing a region near a backlight unit of an example of a liquid crystal display device using the optical film laminated body of the invention.

### BEST MODE FOR CARRYING OUT THE INVENTION

The invention will be described in detail below.

(Reflective Polarizing Film)

The reflective polarizing film in the invention has a water vapor transmittance of from 5 to 20 g/m²/day. In the case where the water vapor transmittance of the reflective polarizing film is less than 5 g/m²/day, water vapor is not evaporated upon constituting the optical film laminated body through an adhesive to make the adhesion property short. In the case where the water vapor transmittance of the reflective polarizing film exceeds 20 g/m²/day, the dimension of the optical film laminated body alters under a high humidity condition to cause distortion on liquid crystal display.

The reflective polarizing film is preferably a uniaxially stretched multilayer laminated film containing 501 layers in total of first layers containing a thermoplastic resin having a positive stress-optical coefficient and having a thickness of from 0.05 to 0.5 μm, and second layers containing a thermoplastic resin and having a thickness of 0.05 to 0.5 μm, which are laminated alternately. In the case where the number of layers is less than 501, the aforementioned target optical characteristics cannot be satisfied over a wavelength of from 400 to 800 nm. The upper limit of the number of layers is preferably 2,001 layers at most from such a standpoint as productivity and handleability of the film. In the case where the thickness of the first layer and the second layer exceeds 0.5 μm, the reflective band is in the infrared range, whereas it is less than 0.05 μm, the reflective range of reflected light is in the ultraviolet range, and in these cases, it is not preferred since usefulness as a reflective polarizing film cannot be obtained.

The reflective polarizing film of the invention, which is the uniaxially stretched multilayer laminated film, has an average reflectivity of 90% or more, preferably 95% or more, and more preferably 98% or more, to a polarized light component in parallel to the plane containing both the stretching direction and the direction perpendicular to the film surface, in a wavelength range of from 400 to 800 nm. In the case where it is less than 90%, it is not preferred since the polarized light reflection capability as a reflective polarizing film is insufficient, and a sufficient capability as a luminance improving film of a liquid crystal display device or the like is not exhibited.

The reflective polarizing film, which is the uniaxially stretched multilayer laminated film, has an average reflectivity of 15% or less, more preferably 13% or less, and particularly preferably 10% or less, to a polarized light component perpendicular to the plane containing both the stretching direction and the direction perpendicular to the film surface, in a wavelength range of from 400 to 800 nm. In the case where it exceeds 15%, it is not preferred since the polarized light transmittance as a reflective polarizing film is lowered, and the capability as a luminance improving film of a liquid crystal display device is deteriorated.

The reflective polarizing film, which is the uniaxially stretched multilayer laminated film, preferably has a difference between the maximum reflectivity and the minimum reflectivity of 10% or less to a polarized light component in parallel to the plane containing both the stretching direction and the direction perpendicular to the film surface, in a wavelength range of from 400 to 800 nm. In the case where the difference between the maximum reflectivity and the minimum reflectivity of the polarized light component exceeds. 10%, it is not preferred since distortion occurs in color tone of light having been reflected or transmitted to cause a problem in display quality upon using as a constitutional member of a liquid crystal display device.

The reflective polarizing film, which is the uniaxially stretched multilayer laminated film, preferably has a difference between the maximum reflectivity and the minimum reflectivity of 10% or less to a polarized light component perpendicular to the plane containing both the stretching direction and the direction perpendicular to the film surface, in a wavelength range of from 400 to 800 nm. In the case where the difference between the maximum reflectivity and the minimum reflectivity of the polarized light component exceeds 10%, it is not preferred since distortion occurs in color tone of light having been reflected or transmitted to cause a problem in display quality upon using as a constitutional member of a liquid crystal display device.

In the reflective polarizing film in the invention, the ratio of the average thickness of the second layers to the average thickness of the first layers is preferably from 0.5 to 5.0, more preferably from 1.0 to 4.0, and particularly preferably from 1.5 to 3.5. In the case where the ratio of the average thickness of the second layers to the average thickness of the first layers is less than 0.5, it is not preferred since the reflective polarizing film is liable to tear in the stretching direction of the uniaxial stretching. In the case where it exceeds 5.0, it is not preferred since the change in thickness of the reflective polarizing film becomes large upon orientation relaxation through heat treatment.

In the reflective polarizing film in the invention, in order to reflect polarized light in a wide wavelength range, the first layers and the second layers are preferably constituted by layers that are different in thickness from each other within a predetermined range. In this case, the ratio of the maximum thickness and the minimum thickness of the first layers and the second layers is preferably from 1.5 to 5.0, more preferably from 2.0 to 4.0, and particularly preferably from 2.5 to 3.5. In the case where it is less than 1.5, it is not preferred since the reflection characteristics cannot be exhibited over a sufficiently wide wavelength range, and in the case where it exceeds 5.0, it is not preferred since the wavelength range where light is reflected becomes too wide, and the reflectivity of polarized light is lowered to fail to obtain a high reflectivity.

In the laminated structure constituted by layers that are different in thickness from each other within a predetermined range, the thickness of the first layers and the second layers may have a distribution where it varies stepwise, or may have a distribution where it various continuously.

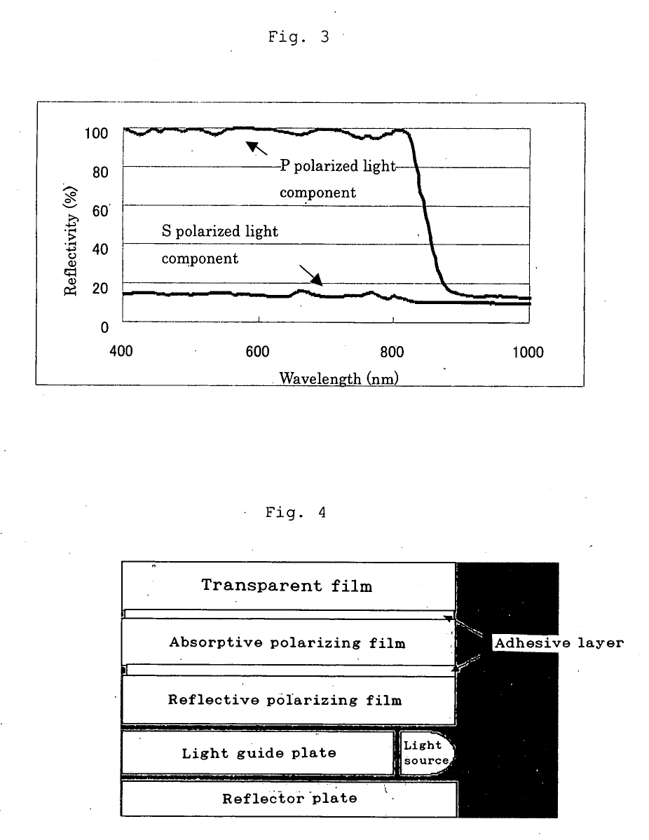

FIG. 3 shows an example of the reflectance curve of the reflective polarizing film in the invention. P polarized light is a polarized light component that is in parallel to a plane containing both the stretching direction of the film and the direction perpendicular to the film surface, and S polarized light is a polarized light component that is perpendicular to a plane containing both the stretching direction of the film and the direction perpendicular to the film surface.

The resin constituting the first layer of the reflective polarizing film in the invention is preferably a thermoplastic resin having a positive stress-optical coefficient. Examples of the thermoplastic resin having a positive stress-optical coefficient include aromatic polyester (such as polyethylene naphthalate, polyethylene terephthalate, polybutyrene terephthalate and poly-1,4-cyclohexanedimethylene terephthalate), polyimide (such as polyacrylic acid amide), polyetherimide, a polyalkylene polymer (such as polyethylene, polypropylene, polybutylene, polyisobutylene and poly(4-methyl)pentene), a fluorinated polymer (such as a perfluoroalkoxy resin, polytetrafluoroethylene, a fluorinated ethylene-propylene copolymer, polyvinylidene fluoride and polychlorotrifluoroethylene), a chlorinated polymer (such as polyvinylidene chloride and polyvinyl chloride), polysulfone, polyethersulfone, polyacrylonitrile, polyamide, a silicone resin, an epoxy resin, polyvinyl acetate, polyetheramide, an ionomer resin, an elastomer (such as polybutadiene, polyisoprene and neoprene), and polyurethane. Among these, aromatic polyester is preferred owing to the relatively large stress-optical coefficient thereof.

As a thermoplastic resin constituting the second layer, a thermoplastic resin having a positive stress-optical coefficient may be used as far as the thermoplastic resin is different from that constituting the first layer, and other thermoplastic resins than that resin may also be used. As the thermoplastic resin having a positive stress-optical coefficient, those described for the first layer may be used. Examples of the other thermoplastic resins include atactic polystyrene, polycarbonate, polymethacrylate (such as polyisobutyl methacrylate, polypropyl methacrylate, polyethyl methacrylate and polymethyl methacrylate), polyacrylate (such as polybutyl acrylate and polymethyl acrylate), syndiotactic polystyrene, syndiotactic poly-α-methylstyrene, syndiotactic polydichlorostyrene, a copolymer and a blend containing arbitrary polystyrene among these, and a cellulose derivative (such as ethylcellulose, cellulose acetate, cellulose propionate, cellulose acetate butyrate and nitrocellulose).

Preferred embodiments of the reflective polarizing film constituted by the first layer and the second layer of the thermoplastic resins will be described below.

(First Layer)

The thermoplastic resin constituting the first layer of the reflective polarizing film is preferably polyester having a melting point of from 260 to 270° C. In the case where the melting point is less than 260° C., the difference in melting point to the thermoplastic resin constituting the second layer becomes small, whereby it becomes difficult to provide a sufficient difference in refractive index, among the layers constituting the reflective polarizing film. Homopolyethylene-2,6-napthalenedicarboxylate generally has a melting point around 267° C.

Examples of the polyester having a melting point of from 260 to 270° C. include homopolyethylene-2,6-napthalenedicarboxylate, and a copolymerized polyethylene-2,6-naphthalenedicarboxylate containing 95% by mol or more of an ethylene-2,6-naphthalenedicarboxylate component as repeating units and 5% by mol or less of another copolymerization component. Particularly preferred examples thereof include homopolyethylene-2,6-napthalenedicarboxylate.

(Second Layer)

The thermoplastic resin constituting the second layer of the reflective polarizing film is preferably polyester having a melting point of from 210 to 255° C., which is lower than the melting point of the thermoplastic resin of the first layer by from 15 to 60° C. In the case where the melting point is higher than the range, the difference in melting point to the thermoplastic resin constituting the first layer becomes small, and it is not preferred since it becomes difficult to provide a sufficient difference in refractive index among the layers constituting the reflective polarizing film. In the case where the melting point is lower than the range, on the other hand, it is not preferred since the adhesion property to the thermoplastic resin constituting the first layer is lowered to fail to provide sufficient adhesion property among the layers constituting the reflective polarizing film.

Examples of a thermoplastic resin satisfying the conditions include a copolymerized polyethylene-2,6-naphthalenedicarboxylate containing from 75 to 97% by mol of an ethylene-2,6-naphthalenedicarboxylate component as repeating units and from 3 to 25% by mol of another copolymerization component.

Examples of the copolymerization component in the first layer and the second layer include an acid component, examples of which include an aromatic carboxylic acid, such as isophthalic acid and 2,7-naphthalenedicarboxylic acid; an aliphatic dicarboxylic acid, such as adipic acid, azelaic acid, sebacic acid and decanedicarboxylic acid; an alicyclic dicarboxylic acid, such as cyclohexanedicarboxylic acid; and a glycol component, examples of which include an aliphatic diol, such as butanediol and hexanediol; and an alicyclic diol, such as cyclohexanedimethanol. Among these, terephthalic acid and isophthalic acid are preferred since they lowers the melting point while maintaining the stretching property.

In the case where the first layer and the second layer of the reflective polarizing film are constituted by polyethylene-2,6-naphthalene dicarboxylate and a copolymer thereof, respectively, it is preferred since high thermal dimensional stability can be obtained, and in particular, a process requiring a high temperature of 160° C. or more can be adopted.

(Lamination)

Lamination of the first layer and the second layer may be carried out, for example, in such a manner that polyester for the first layer is branched to plural layers, for example, 251 layers, and polyester for the second layer is branched to plural layers, for example, 250 layers, with a feed block, and the first layer and the second layer are laminated alternately in the feed block. The feed block is preferably such a one that the thicknesses of the flow paths of the layers, in which the polymers flow, vary continuously in a range of from 1 to 3 times. The lamination of the first layer and the second layer may be carried out, for example, in such a manner that a fluid obtained by laminating 201 uniform layers is divided into three perpendicularly to the laminated surface to a ratio, for example, of 1.0/1.3/2.0, and the divided fluid is laminated in the direction perpendicular to the laminated surface to 600 odd layers.

The multilayer laminated unstretched film thus obtained is unidirectionally stretched to obtain the reflective polarizing film. The stretching direction of the film may be either the machine direction (lengthwise direction) or the crosswise direction. Since an absorptive polarizing film is generally produced by stretching in the machine direction, good productivity is obtained when the stretching direction of the reflective polarizing film is the machine direction, by which the reflective polarizing film and the absorptive polarizing film can be laminated by a roll-to-roll process. Accordingly, the stretching is preferably carried out in the machine direction.

The stretching may be carried out by known stretching methods, such as heat stretching with a bar heater, roll heat stretching and tenter stretching. Among these, the tenter stretching method is preferred since scratches caused by contact with a roll can be reduced, and a high stretching speed can be obtained.

The uniaxially stretched film thus stretched is then preferably heat-treated, whereby at least one of the layers is partially melted to relax the orientation. The heat treatment is carried out at a temperature that is higher than the melting point of the thermoplastic resin of one of the layers and lower than the melting point of the thermoplastic resin of the other layer.

The reflective polarizing film preferably has two or more melting points measured with a differential scanning calorimeter with the melting points being different by 5° C. or more. In the melting points measured herein, in general, the melting point on the higher temperature side is the first layer exhibiting a higher refractive index, and the melting point on the lower temperature side is the second layer exhibiting a lower refractive index.

One of the layers after stretching is melted at least partially. The crystallization peak measured with a differential scanning calorimeter is preferably present in a range of from 150 to 220° C. In the case where the crystallization peak is less than 150° C., it is not preferred since the film forming property upon forming the film is deteriorated, and the uniformity in film quality is deteriorated, due to the rapid crystallization of one of the layers upon stretching the film, so as to cause variegation in color tone. In the case where the crystallization peak exceeds 220° C., it is not preferred since crystallization occurs simultaneously with melting of one of the layers through heat treatment, whereby it is difficult to exhibit a sufficient difference in refractive index.

The reflective polarizing film having a water vapor transmittance of from 5 to 20 g/m²/day, which is required in the optical film laminated body of the invention, can be obtained with the aforementioned reflective polarizing film.

The reflective polarizing film in the invention preferably has a breaking strength in the stretching direction of 100 MPa or more, more preferably 150 MPa or more, and particularly preferably 200 MPa or more, and preferably has a breaking strength in the crosswise direction of 100 MPa or more, more preferably 150 MPa or more, and particularly preferably 200 MPa or more. In the case where the breaking strength is less than 100 MPa, it is not preferred since the handleability upon processing the reflective polarizing film is deteriorated, and the durability of the optical film laminated body is lowered. In the case where the breaking strength is 100 MPa or more, such advantages are obtained that the film becomes firm to improve the winding property. The upper limit of the breaking strength is preferably 500 MPa at most from the standpoint of maintaining the stability upon stretching. The ratio of the breaking strength in the lengthwise direction to that in the cross wise direction is preferably 3 or less, and more preferably 2 or less. It is preferred that the ratio is in the range since sufficient tearing resistance can be obtained.

(Adhesion Facilitating Layer)

The reflective polarizing film of the invention preferably has an adhesion facilitating layer on at least one surface thereof for improving the adhesion property to the absorptive polarizing film. The adhesion facilitating layer preferably contains a polymer component containing polyvinyl alcohol from the standpoint of improving the adhesion property to a polyvinyl alcohol adhesive used for lamination.

The polymer component of the adhesion facilitating layer preferably contains from 55 to 85% by weight of co-polyester having a glass transition point of from 20 to 90° C. and from 15 to 45% by weight of polyvinyl alcohol having a saponification degree of from 80 to 90% by mol. In the case where the amount of the co-polyester is less than 55% by weight, it is not preferred since the adhesion property to the reflective polarizing film is lowered, and in the case where it exceeds 85% by weight, it is not preferred since the adhesion property to the absorptive polarizing film is lowered. In the case where the amount of the polyvinyl alcohol is less than 15% by weight, it is not preferred since the adhesion property to an ink image receiving layer is insufficient, and in the case where it exceeds 45% by weight, it is not preferred since the anti-blocking property is lowered. The glass transition point (hereinafter, which is abbreviated as Tg in some cases) of the co-polyester of the adhesion facilitating layer is preferably from 20 to 90° C., and more preferably from 25to 80° C. In the case where Tg is less than 20° C., it is not preferred since the film is liable to cause blocking, and in the case where it exceeds 90° C., it is not preferred since the film is lowered in scraping property and adhesion property.

The co-polyester of the adhesion facilitating layer preferably contains a dicarboxylic acid component having a sulfonate salt group in an amount of from 1 to 16% by mol, and more preferably from 1.5 to 14% by mol, per 100% by mol of the total carboxylic acid component constituting the co-polyester, from the standpoint of imparting hydrophilicity. In the case where the amount of the dicarboxylic acid component having a sulfonate salt group is less than 1% by mol, it is not preferred since the co-polyester is short in hydrophilicity, and in the case where it exceeds 16% by mol, it is not preferred since the coated layer is lowered in humidity resistance.

As the co-polyester, such a co-polyester can be used that is constituted by a carboxylic acid component, such as terephthalic acid, isophthalic acid, 2,6-naphthalenedicarboxylic acid, hexahydroterephthalic acid, 4,4′-diphenyldicarboxylic acid, phenylindanedicarboxylic acid, adipic acid, sebacic acid, 5-sulfoisophthalic acid, trimellitic acid and dimethylolpropionic acid, a dicarboxylic acid component having a sulfonate salt group, such as 5-Na sulfoisophthalic acid, 5-K sulfoisophthalic acid and 5-K sulfoterephthalic acid, a hydroxyl compound component, such as ethylene glycol, diethylene glycol, neopentylene glycol, 1,4-butanediol, 1,6-hexanedionl, 1,4-cyclohexanedimethanol, glycerin, trimethylolpropane and an alkylene oxide adduct of bisphenol A.

As the polyvinyl alcohol, one having a saponification degree of from 80 to 90% by mol is used. In the case where the saponification degree is less than 80% by mol, it is not preferred since the adhesion facilitating layer is lowered in humidity resistance, and in the case where it exceeds 90% by mol, it is not preferred since the adhesion property to the absorptive polarizing film is lowered.

The adhesion facilitating layer preferably contains a crosslinking agent represented by the following formula (I) in an amount of from 5 to 20 parts by weight per 100 parts by weight of the polymer component containing the co-polyester and the polyvinyl alcohol, from the standpoint of attaining both the adhesion property and the winding property of the film: 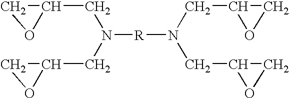
wherein R represents

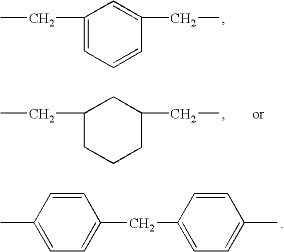

The use of the crosslinking agent provides considerably firm adhesion between the adhesion facilitating layer and a polyvinyl alcohol adhesive used as an adhesive. In the case where the amount of the crosslinking agent is less than 5 parts by weight, it is not preferred since the adhesion property upon adhering to the absorptive polarizing film is lowered, and in the case where it exceeds 20 parts by weight, it is not preferred since the antiblocking property is lowered, and the adhesion property to the reflective polarizing film is lowered.

The adhesion facilitating layer preferably contains fine particles having an average particle diameter of from 20 to 80 nm in an amount of from 3 to 25 parts by weight per 100 parts by weight of the polymer component containing the co-polyester and the polyvinyl alcohol, from the standpoint of imparting sliding property to the film. In the case where the amount of the fine particles is less than 3 parts by weight, it is not preferred since the sliding property of the film is lowered to make the conveying property short, and in the case where it exceeds 25 parts by weight, it is not preferred since the scraping property is lowered.

The adhesion facilitating layer preferably has surface energy of from 50 to 65 dyne/cm, and more preferably from 52 to 60 dyne/cm. In the case where the surface energy is less than 50 dyne/cm, it is not preferred since the adhesion property to the absorptive polarizing film is deteriorated, and in the case where it exceeds 65 dyne/cm, it is not preferred since the adhesion property to the reflective polarizing film is lowered, and the humidity resistance of the coated layer is lowered. The coated layer having surface energy of from 50 to 65 dyne/cm can be obtained by laminating the aforementioned coating material on the reflective polarizing film to a thickness, for example, of from 0.02 to 1 μm.

The adhesion facilitating layer preferably has a center line average roughness (Ra) on the surface of the coated layer of from 10 to 250 nm from the standpoint of improving the blocking resistance and the conveying property of the film. The adhesion facilitating layer having Ra in the range can be provided by coating an aqueous coating composition, preferably an aqueous solution, an aqueous dispersion liquid or an emulsion, constituting the adhesion facilitating layer on the reflective polarizing film.

The aqueous coating composition may contain an antistatic agent, a coloring agent, a surfactant and an ultraviolet ray absorbent.

The coating method of the aqueous coating composition may be arbitrarily selected from known coating methods. For example, such a method can be applied as a roll coating method, a gravure coating method, a roll brush coating method, a spray coating method, an air knife coating method, an impregnation coating method and a curtain coating method. The methods may be employed solely or in combination. The coated amount of the coating composition is preferably from 0.5 to 20 g, and more preferably from 1 to 10 g, per 1 m² of the running film.

(Absorptive Polarizing Film)

The absorptive polarizing film used in the invention has been known as it is, and can be obtained by adsorbing a dichroic substance, such as iodine, to a polymer film, followed by crosslinking, stretching and drying. As the polymer film, a hydrophilic polymer film is used. Examples of the hydrophilic polymer film include a PVA film, a partially formalated PVA film, a partially saponified ethylene-vinyl acetate copolymer film, a cellulose film, a dehydrated PVA film and a dehydrochlorinated polyvinyl chloride film. A PVA film is preferred from the standpoint of improving the light transmittance and the degree of polarization. The thickness of the absorptive polarizing film is preferably from 1 to 80 μm.

(Transparent Film)

The transparent film in the invention is a film having transparency used for protecting the absorptive polarizing film in the process. The transparent film in the invention necessarily has a water vapor transmittance of from 100 to 500 g/m²/day. In the case where the water vapor transmittance of the transparent film is less than 100 g/m²/day, water vapor is not sufficiently evaporated upon constituting the optical film laminated body through an adhesive to make the adhesive property short. In the case where the water vapor transmittance of the transparent film exceeds 500 g/m²/day, the optical film laminated body is changed in dimension under high humidity conditions to cause distortion in liquid crystal display.

The transparent film preferably has a haze of 1% or less for ensuring sufficient transmitted light. The transparent film is preferably a transparent film having low birefringence from the standpoint of maintaining the polarized state of light transmitted through the liquid crystal. The low birefringence herein means that the differences in refractive index in the three-dimensional directions (X, Y, Z) are 0.1 or less in all the directions.

The transparent film can be obtained by selecting a transparent film that has the aforementioned water vapor transmittance from known transparent films. Examples of the transparent film include cellulose, polyester, polynorbornene, polycarbonate, polyamide, polyimide, polyethersulfone, polysulfone, polystyrene, polyolefin, acrylate and acetate. From the standpoint of polarizing property and durability, TAC is preferred among cellulose, and TAC with a surface having been subjected to a saponification treatment is particularly preferred. In the case where a TAC film is used, it is preferably used with a thickness of from 20 to 80 μm for ensuring the water vapor transmittance.

The material of the transparent film may also be a thermoplastic resin other than those mentioned above, a thermosetting resin and an ultraviolet ray-curing resin. For example, such a resin composition may be used that contains a thermoplastic resin having a substituted or unsubstituted imide group on the side chain and a thermoplastic resin having a substituted or unsubstituted phenyl group and a nitrile group on the side chain. Specific examples thereof include a resin composition containing an alternating copolymer of isobutene and N-methylmaleimide and an acrylonitrile-styrene copolymer. The composition is disclosed in JP-A-2001-343529 (WO01/37007) Examples of the thermosetting resin and the ultraviolet ray-curing resin include acrylate, urethane, acrylic urethane, epoxy and silicone.

The transparent film may be an unstretched film or a stretched film. The stretching may be uniaxially or biaxially stretching. An optical compensation retardation film is preferably used as the transparent film, and a uniaxially stretched film is preferably used as the transparent film for the purpose.

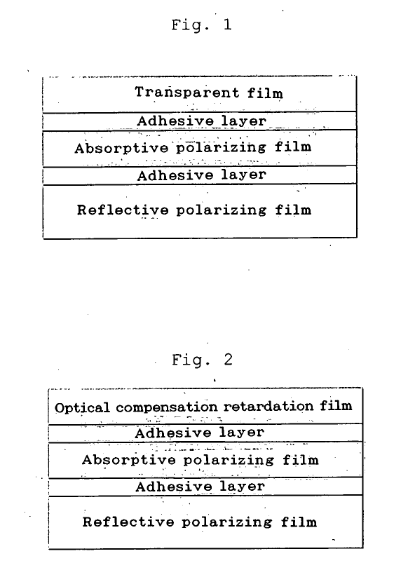

FIG. 2 shows a constitutional example where an optical compensation retardation film is used as the transparent film. The optical compensation retardation film is a film that compensates change in color tone depending on the angle of the liquid crystal and the absorptive polarizing film. While it varies depending on the display system of the liquid crystal display device, in the case of a vertically aligned liquid crystal (VA mode liquid crystal), for example, such an optical compensation retardation film is preferred that has a retardation in the in-plane direction (Rd) shown by the following expression of from 40 to 60 nm and a retardation in the thickness direction (Rth) shown by the following expression of from 100 to 150 nm.
Rd=(nx−ny)·d
Rth=[[(nx+ny)/2]−nz]·d

In the expressions, nx, ny and nz represent the refractive indices in the X axis, Y axis and Z axis, respectively, and d represents the thickness of the layer.

Examples of the optical compensation retardation film that has a water vapor transmittance necessary for the transparent film in the invention include a stretched film of modified triacetyl cellulose, in which acetyl groups of TAC are partially substituted by propionate, and a stretched film of a resin composition containing an alternating copolymer of isobutene and N-methylmaleimide and an acrylonitrile-styrene copolymer. In the case where these optical compensation retardation films are used, they are preferably used with a thickness of from 5 to 40 μm for ensuring the water vapor transmittance.

(Optical Film Laminated Body)

The optical film laminated body of the invention is constituted by adhering a reflective polarizing film on one surface of an absorptive polarizing film and adhering a transparent film on the other surface thereof. The adhering operation is preferably carried out by using an adhesive. Accordingly, the optical film laminated body of the invention preferably has such a constitution that a reflective polarizing film is laminated on one surface of an absorptive polarizing film through an adhesive layer, and a transparent film is laminated on the other surface thereof through an adhesive. Examples of the adhesive include polyvinyl alcohol, an acrylate polymer, a silicone polymer, polyester, polyurethane, polyether and synthetic rubber. Polyvinyl alcohol is preferred as the adhesive since good adhesion property to the absorptive polarizing film is obtained.

The optical film laminated body of the invention can be used as a constitutional member of a liquid crystal display device. FIG. 4 shows an example where the optical film laminated body of the invention is used as a constitutional member of a liquid crystal display device.

As shown in FIG. 4, a light source is disposed on a side surface of a light guide plate, a reflector plate is disposed on one surface of the light guide plate, and the optical film laminated body of the invention is disposed on the other surface thereof. The side of the transparent film of the optical film laminated body of the invention is used as the viewing side.

Light emitted from the light source is transmitted through the light guide plate and separated into two linear polarized light components with the reflective polarizing film on the light guide plate. One of the polarized light components is transmitted through the reflective polarizing film and is incident on the absorptive polarizing film. The polarized light component is transmitted through the absorptive polarizing film in the case where the direction of the linear polarized light agrees with the transmission axis of the absorptive polarizing film. The other of the polarized light components is reflected by the reflective polarizing film and again incident on the light guide plate, and it is then reflected by the reflector plate on the back surface of the light guide plate and is incident on the reflective polarizing film through the light guide plate. Upon being reflected by the reflector plate, polarization of the polarized light is partially eliminated to be natural light. The natural light is separated into two linear polarized light components with the reflective polarizing film. The polarized light component is transmitted through the absorptive polarizing film in the case where the direction of the linear polarized light agrees with the transmission axis of the absorptive polarizing film. Accordingly, the light that has been conventionally lost by absorption with the absorptive polarizing film is reused, whereby the luminance of the liquid crystal display device is improved.

Examples of the light source include a linear light source, such as a cold cathode ray tube and a hot cathode ray tube, and a light emission diode.

Examples of the light guide plate include a transparent or translucent resin plate having a diffusion member in a dot form or a stripe form provided on a light emission surface or a back surface of the plate, and a transparent or translucent resin plate having a relief structure provided on the back surface of the plate. The light guide plate has by itself a function of converting the polarized state of light reflected by the reflective polarizing film, but it is preferred to dispose the reflector plate on the back surface thereof as mentioned above since reflection loss can be prevented with high efficiency. As the reflector plate, a diffusion reflector plate and a mirror reflection plate are preferred owing to the excellent conversion capability of reflected light. The diffusion reflector plate generally has a relief surface and can eliminate the mixed polarized state of polarized light based on the diffusion characteristics thereof. The mirror reflector plate has on the surface thereof, for example, a metallic surface, such as a vapor-deposited film or a metallic foil of aluminum, silver or the like, and reverses the polarized state of circularly polarized light through reflection thereof.

The optical film laminated body of the invention exhibits its effect significantly upon installing in an image display device with a large screen since it can suppress fluctuation in luminance and chroma. In order to obtain the effect, the size of the optical film laminated body is preferably from 250 mm or more, and-more preferably 350 mm or more, in terms of diagonal length.

The optical film laminated body of the invention can be used as constituting a liquid crystal display device by disposing at least on one surface of a liquid crystal cell.

In a liquid crystal display device, in order to obtain the aforementioned effect, the optical film laminated body of the invention is disposed on the back surface side, i.e., the side of the light source, of the liquid crystal cell. The optical film laminated body is disposed in such a direction that the reflective polarizing film, the absorptive polarizing film and the transparent film are aligned in this order from the side of the light guide plate, as shown in FIG. 4. In other words, the optical film laminated body is disposed to make the side of the reflective polarizing film directed to the light guide plate.

The optical film laminated body of the invention may be laminated and integrated with the light guide plate or the reflector plate through an adhesive or a tackiness agent. The lamination and integration suppresses reflection loss at the interfaces between the members and the air, and invasion of foreign matters and displacement of the members can be prevented from occurring, whereby the display quality, the compensation efficiency and the polarized light conversion efficiency can be prevented from being decreased.

The optical film laminated body of the invention may be imparted with a function of absorbing an ultraviolet ray. For that purpose, an ultraviolet ray absorbent, such as a salicylate ester compound, a benzophenol compound, a benzotriazole compound, a cyanoacrylate compound and a nickel complex salt compound, may be mixed, for example, with the reflective polarizing film.

The optical film laminated body of the invention can be used by disposing on one surface of a liquid crystal cell of a liquid crystal display device, and can be applied, for example, to liquid crystal display devices of a reflection type, a semi-transmission type and a transmission-reflection dual purpose type.

Examples of the liquid crystal cell include a liquid crystal cell of an active matrix driven type represented by a thin film transistor (TFT) type, and a liquid crystal cell of a simple matrix driven type represented by a TN (twist nematic) type and an STN (super twist nematic) type. A guest-host type liquid crystal cell, in which a non-twist liquid crystal or a dichroic substance is dispersed in a liquid crystal, a liquid crystal cell using a ferroelectric liquid crystal, a VA (vertical aligned) type liquid crystal cell, and a monodomain orientation liquid crystal cell may also be used. The optical film laminated body of the invention is preferably used in combination with a liquid crystal cell of a display mode of a TN type, an STN type or an OCB (optically aligned birefringence) type among these.

The optical film laminated body of the invention can be applied to, in addition to a liquid crystal display device, a self-luminous display device, such as an organic electroluminescent (EL) display, PDP, a plasma display (PD) and FED (field emission display).

### EXAMPLE

The invention will be described in more detail below with reference to examples. The physical properties and characteristics in the examples were measured or evaluated in the following manners.

(1) Melting Point

A melting point was measured by using 10 mg of a specimen with a differential scanning calorimeter (DSC2920, produced by TA Instruments) at a temperature increasing rate of 20° C. per minute.

(2) Thickness of Layers

A triangular specimen was cut from the film, and after fixing in an embedding capsule, was embedded with an epoxy resin. The embedded specimen was cut in the film forming direction and the thickness direction with a microtome (ULTRACUT-S, produced by Reichert Jung) to obtain a thin film specimen having a thickness of 50 nm. The resulting thin film specimen was observed and imaged with a transmission electron microscope (JEM2010, produced by JEOL) at an acceleration voltage of 10 kV, and the layers were measured for thickness from the micrograph. The target for measuring the thickness was a layer having a thickness of from 0.05 to 0.5 μm.

(3) Optical Characteristics of Reflective Polarizing Film

By using a spectrophotometer (MPC-3100, produced by Shimadzu Corp.), a polarizing filter was attached to the side of the light source, and the relative mirror reflectivity based on an aluminum vapor-deposited mirror was measured for each wavelength in a range of from 400 to 800 nm. The measured value obtained upon disposing the stretching direction of the reflective polarizing film agreeing with the transmission axis of the polarizing filter was designated as P polarized light, and the measured value obtained upon disposing the stretching direction of the reflective polarizing film perpendicular to the transmission axis of the polarizing filter was designated as S polarized light. For each of the polarized light components, the average value of reflectivities in a range of from 400 to 800 nm was designated as an average reflectivity, the maximum value among the measured reflectivities was designated as a maximum reflectivity, and the minimum value among them was designated as a minimum reflectivity. The maximum difference in reflectivity is defined by the following expression.
Maximum difference in reflectivity(%)=Maximum reflectivity(%)−Minimum reflectivity(%)
(4) Water Vapor Transmittance

The water vapor transmittance was measured according to JIS Z0208. The measurement was carried out at an area for water vapor transmission of 30 cm², and conditions of 40° C. and 90% RH.

(5) Heat Cycle Test

A specimen of the optical film laminated body was subjected to 200 cycles of a cycle test at a temperature of 80° C. for 1 hour and a temperature of −20° C. for 1 hour as one cycle under a humidity of 90%, the appearance of the optical film laminated layer was evaluated based on the following standard.
A: No appearance change was observed.
B: Whitening or detachment of films was observed in the specimen.
   (6) Long-Term Durability

A specimen of the optical film laminated body was subjected to a heat and humidity test by allowing to stand in an environment of a humidity of 95% and a temperature of 65° C. for 1,000 hours. The holding ratio of the degree of polarization after the heat and humidity test relative to the value before the heat and humidity test was calculated by the following expression. The holding ratio was evaluated as the long-term durability based on the following standard.
Holding ratio of degree of polarization=Degree of polarization after heat and humidity test/Degree of polarization before heat and humidity test
A: Holding ratio of degree of polarization after heat and humidity test was 95% or more.
B: Holding ratio of degree of polarization after heat and humidity test was less than 95%.
-: Measurement could not be carried out due to insufficient adhesion property.

### Example 1

(Formation of Reflective Polarizing Film)

As polyester for the first layer, polyethylene-2,6-naphthalene dicarboxylate having an intrinsic viscosity of 0.62 (in o-chlorophenol at 35° C.) was mixed with true spherical silica particles (average particle diameter: 0.3 μm, ratio of major diameter to minor diameter: 1.02, average deviation of particle diameter: 0.1) in an amount of 0.15% by weight. As polyester for the second layer, polyethylene-2,6-naphthalene dicarboxylate copolymerized with 10% by mol of terephthalic acid having an intrinsic viscosity of 0.62 (in o-chlorophenol at 35° C.) was prepared.

The polyester for the first layer and the polyester for the second layer were separately dried at 170° C. for 5 hours and then fed to an extruder for heating to 300° C. to obtain molten polymers. By using a multilayer feed block, the molten polymers of the polyester for the first layer and the polyester for the second layer were branched into 301 layers and 300 layers, respectively, and the first layers and the second layers were laminated alternately to obtain a laminated body of the molten polymers. In this case, the multilayer feed block used was one where the thicknesses of the layers varied continuously in a range of from 1 to 3 times from the maximum to the minimum. The laminated body of the molten polymers was fed to a die while maintaining the laminated state thereof, and was cast on a casting drum. At this time, the thickness ratio of the first layers and the second layers was controlled to 1.0/2.0. As shown in Tables 1 and 2, an unstretched multilayer laminated film containing 601 layers in total of the first layers and the second layers laminated alternately was obtained.

In Table 1, PEN means polyethylene-2,6-naphthalene dicarboxylate, TA10PEN means polyethylene-2,6-naphthalene dicarboxylate copolymerized with 10% by mol of terephthalic acid.

TABLE 1

| | First layers | | | Second layers | | | |
|---|---|---|---|---|---|---|---|
| | Resin | | | Resin | | | Total |
| | | Melting | Number | | Melting | Number | number |
| | Kind | point (° C.) | of layers | Kind | point (° C.) | of layers | of layers |
| Example 1 | PEN | 269 | 301 | TA10PEN | 247 | 300 | 601 |
| Comparative | PEN | 269 | 401 | TA10PEN | 247 | 400 | 801 |
| Example 1 | | | | | | | |

TABLE 2

| | Thickness | | | | | | | | |
|---|---|---|---|---|---|---|---|---|---|
| | | Surface | | First layers | | | Second layers | | |
| | | thick film | Layer | Maximum | Minimum | | Maximum | Minimum | |
| | Total | layer (one | thickness | thickness | thickness | Maximum/ | thickness | thickness | Maximum/ |
| | (μm) | side) (μm) | ratio | (nm) | (nm) | minimum | (nm) | (nm) | minimum |
| Example 1 | 55 | — | 2.0 | 15 | 46 | 3.0 | 31 | 92 | 3.0 |
| Comparative | 155 | 40 | 2.0 | 15 | 46 | 3.0 | 31 | 92 | 3.0 |
| Example 1 | | | | | | | | | |

TABLE 3

| | Stretching in | | Stretching in | | |
|---|---|---|---|---|---|
| | film forming | | crosswise | | Thermal |
| | direction | | direction | | fixing |
| | Magnification | Temperature | Magnification | Temperature | Temperature |
| | (times) | (° C.) | (times) | (° C.) | (° C.) |
| Example 1 | 1.0 | — | 5.2 | 135 | 245 |
| Comparative | 1.0 | — | 5.2 | 135 | 245 |
| Example 1 | | | | | |

An aqueous coating composition for providing an adhesion facilitating layer was prepared. Accordingly, such an aqueous coating composition was prepared that contained at a solid concentration of 4% by weight a composition containing 51% by weight of co-polyester (Tg: 30° C.) formed of a dicarboxylic acid component containing 60% by mol of terephthalic acid, 36% by mol of isophthalic acid and 4% by mol of 5-Na sulfoisophthalic acid and a glycol component containing 60% by mol of ethylene glycol and 40% by mol of neopentyl glycol, 20% by weight of polyvinyl alcohol having a saponification degree of from 86 to 89% by mol, 10% by weight of crosslinked acrylate resin particles having an average particle diameter of 40 nm, 10% by weight of a crosslinking agent represented by the following formula (II), and 9% by weight of polyoxyethylene lauryl ether.

In the solid content of the aqueous coating composition, the ratio of the co-polyester was 72% by weight, and the ratio of the polyvinyl alcohol was 28% by weight, in the polymer component containing the co-polyester and the polyvinyl alcohol. The amount of the crosslinked acrylate resin particles was 14 parts by weight, the amount of the crosslinking agent was 14 parts by weight, and the amount of the polyoxyethylene lauryl ether was 13 parts by weight, per 100 parts by weight of the polymer component containing the co-polyester and the polyvinyl alcohol.

The coating composition was coated on one surface of the unstretched multilayer laminated film with a roll coater, and while drying the coated layer, the film was stretched in the machine direction in 5.2 times at a temperature of 135° C., and then thermally fixed at 245° C. for 3 seconds, as shown in Table 3, so as to obtain a reflective polarizing film, which was a uniaxially stretched multilayer laminated film. The resulting reflective polarizing film had a thickness of 55 μm and a water vapor transmittance of 8.0 g/m²/day. The physical properties of the reflective polarizing film are shown in Table 4.

TABLE 4

| | Optical characteristics | | | | |
|---|---|---|---|---|---|
| | P polarized light | | S polarized light | | |
| | component | | component | | |
| | Average | Maximum | Average | Maximum | Water vapor |
| | reflectivity | difference in | reflectivity | difference in | transmittance |
| | (%) | reflectivity (%) | (%) | reflectivity (%) | (g/m²/day) |
| Example 1 | 98 | 5 | 12 | 5 | 8.0 |
| Comparative | 98 | 5 | 12 | 5 | 2.5 |
| Example 1 | | | | | |

(Formation of Optical Film Laminated Body)

As the absorptive polarizing film, such an absorptive polarizing film having a thickness of 30 μm was prepared that was a PVA film containing iodine. The absorptive polarizing film was adhered to the reflective polarizing film on the surface of on the side of the adhesion facilitating layer by using a polyvinyl alcohol adhesive in such a manner that the polarizing axes of the absorptive polarizing film and the reflective polarizing film agreed with each other.

Subsequently, a TAC film having a water vapor transmittance of 320 g/m²/day and a thickness of 100 μm was adhered to the other surface of the absorptive polarizing film by using a polyvinyl alcohol adhesive shown below. An optical film laminated body having a total thickness of 190 μm was obtained. The characteristics of the optical film laminated body are shown in Table 5. The symbol “−” in the column of long-term durability means that measurement cannot be carried out due to insufficient adhesion property. The polyvinyl alcohol adhesive was produced by adding 3 parts by weight of carboxyl group-modified polyvinyl alcohol (Kuraray Poval KL318, produced by Kuraray Co., Ltd.) and 1.5 parts by weight of a water soluble polyamide epoxy resin (Sumirez Resin 650, produced by Sumitomo Chemical Co., Ltd. (aqueous solution having a solid concentration of 30%)) to 100 parts by weight of water.

P polarized light is a polarized light component that is in parallel to a plane containing both the stretching direction of the film and the direction perpendicular to the film surface, and S polarized light is a polarized light component that is perpendicular to a plane containing both the stretching direction of the film and the direction perpendicular to the film surface.

TABLE 5

| | Reflective | | | | | Optical film | |
|---|---|---|---|---|---|---|---|
| | polarizing film | | Transparent film | | | laminated | |
| | | Water vapor | | | Water vapor | body | |
| | Thickness | transmittance | | Thickness | transmittance | heat cycle | Long-term |
| | (μm) | (g/m²/day) | Kind | (μm) | (g/m²/day) | test | durability |
| Example 1 | 55 | 8.0 | TAC | 100 | 320 | A | A |
| Example 2 | 55 | 8.0 | olefin maleimide | 20 | 120 | A | A |
| | | | polymer | | | | |
| Comparative | 155 | 2.5 | TAC | 100 | 320 | B | — |
| Example 1 | | | | | | | |
| Comparative | 55 | 8.0 | TAC | 40 | 800 | A | B |
| Example 2 | | | | | | | |
| Comparative | 55 | 8.0 | norbornene | 100 | 0.5 | B | — |
| Example 3 | | | polymer | | | | |
| Comparative | 55 | 8.0 | cycloolefin | 100 | 0.5 | B | — |
| Example 4 | | | polymer | | | | |
| Comparative | 55 | 8.0 | polycarbonate | 100 | 1.0 | B | — |
| Example 5 | | | polymer | | | | |

### Example 2

An optical film laminate body having a total thickness of 110 μm was obtained in the same manner as in Example 1 except that an optical compensation retardation film having a thickness of 20 μm and a water vapor transmittance of 120 g/m²/day formed of an olefin maleimide polymer was used as a transparent film. The adhesion surface of the retardation film formed of an olefin maleimide polymer adhered to the PVA film was subjected to a corona treatment in advance. The characteristics of the resulting optical film laminated body are shown in Table 5.

The optical compensation retardation film formed of an olefin maleimide polymer was produced in the following manner. 400 mL of toluene as a polymerization solvent, 0.001 mol of perbutyl neodecanoate as a polymerization initiator, 0.42 mol of N-(2-methylphenyl)maleimide and 4.05 mol of isobutene were charged in a 1-L autoclave, and polymerization reaction was carried out under the polymerization condition of a polymerization temperature of 60° C. and a polymerization time of 5 hours to obtain an N-(2-methylphenyl)maleimide-isobutene alternating copolymer. The resulting N-(2-methylphenyl)maleimide-isobutene alternating copolymer had a weight average molecular weight (Mw) (standard polystyrene conversion) of 160,000 and a molecular weight distribution (Mw/Mn) expressed by weight average molecular weight (Mw)/number average molecular weight (Mn) of 2.7. A solution containing 20% by weight of the resulting N-(2-methylphenyl)maleimide-isobutene alternating copolymer and 80% by weight of methylene chloride was prepared. The solution was cast on a polyethylene terephthalate film, and an N-(2-methylphenyl)maleimide-isobutene alternating copolymer film formed after evaporation of methylene chloride and solidification of the solution was released. The released film was further dried at 100° C. for 4 hours and from 120° C. to 160° C. with a step of 10° C. for 1 hour each, and thereafter dried at 180° C. in vacuum for 4 hours, so as to obtain a film having a thickness of about 40 μm. A small piece of 5 cm×5 cm was cut out from the film and subjected to uniaxial stretching with free width at +50% under conditions of a temperature of 220° C. and a stretching speed of 15 mm/min by using a biaxially stretching apparatus (produced by Shibayama Scientific Co., Ltd.) to obtain an optical compensation retardation film having a thickness of about 20 μm.

### Comparative Example 1

A reflective polarizing film having a thickness of 155 μm was obtained in the manner in Example 1 except that no adhesion facilitating layer was provided on the non-stretched multilayer laminated film, but a polyester layer for the first layer was laminated thereon instead. The reflective polarizing film had a water vapor transmittance of 2.5 g/m²/day. An optical film laminated body having a total thickness of 290 μm was obtained in the same manner as in Example 1 by using the reflective polarizing film. The characteristics of the resulting optical film laminated body are shown in Table 5.

### Comparative Example 2

An optical film laminated body having a total thickness of 130 μm was obtained in the same manner as in Example 2 except that a TAC film having a thickness of 40 μm was used as a transparent film. The TAC film had a water vapor transmittance of 800 g/m²/day. The characteristics of the resulting optical film laminated body are shown in Table 5.

### Comparative Example 3

An optical film laminated body having a total thickness of 190 μm was obtained in the same manner as in Example 2 except that a transparent film of a norbornene polymer having a thickness of 100 μm was used as a transparent. film. The transparent film of a norbornene polymer had a water vapor transmittance of 0.5 g/m²/day. The characteristics of the resulting optical film laminated body are shown in Table 5.

### Comparative Example 4

An optical film laminated body having a total thickness of 190 μm was obtained in the same manner as in Example 2 except that a transparent film of a cycloolefin polymer having a thickness of 100 μm (ZEONOR (R) ZF14 Type, produced by Zeon Corp.) was used as a transparent film. The transparent film of a cycloolefin polymer had a water vapor transmittance of 0.5 g/m²/day. The characteristics of the resulting optical film laminated body are shown in Table 5.

### Comparative Example 5

An optical film laminated body having a total thickness of 190 μm was obtained in the same manner as in Example 2 except that a transparent film of polycarbonate having a thickness of 100 μm (PANLITE (R) produced by Teijin Chemicals Ltd.) was used as a transparent film. The transparent film of a cycloolefin polymer had a water vapor transmittance of 1.0 g/m²/day. The characteristics of the resulting optical film laminated body are shown in Table 5.

### Advantage of the Invention

According to the invention, such an optical film laminated body can be provided that is an optical film laminated body haying an absorptive polarizing film on one surface of a reflective polarizing film, but provides high adhesion property between the reflective polarizing film and the absorptive polarizing film, causes no appearance failure due to warpage or interlayer detachment, and has high durability upon long-term use. The invention can also provide such a novel optical film laminated body that is constituted by a smaller number of constitutional members than conventional products, and is excellent in productivity.

### INDUSTRIAL APPLICABILITY

The optical film laminated body of the invention can be favorably used as a constitutional member of a liquid crystal display device, and when it is used as a constitutional member of a backlight unit of a liquid crystal display device, such a liquid crystal display device can be obtained that has a high and uniform luminance.

1. An optical film laminated body comprising a reflective polarizing film, an absorptive polarizing film and a transparent film in this order, characterized in that a transmission axis of the reflective polarizing film is in parallel to a transmission axis of the absorptive polarizing film, the reflective polarizing film has a water vapor transmittance of from 5 to 20 g/m²/day, and the transparent film has a water vapor transmittance of from 100 to 500 g/m²/day.

2. The optical film laminated body according to claim 1, wherein the reflective polarizing film is a uniaxially stretched film that has an average reflectivity of 90% or more to a polarized light component in parallel to a plane containing both a stretching direction of the uniaxially stretched film and a direction perpendicular to a film surface in a wavelength range of from 400 to 800 nm, and has an average reflectivity of 15% or less to a polarized light component perpendicular to a plane containing both a stretching direction of the uniaxially stretched film and a direction perpendicular to a film surface in a wavelength range of from 400 to 800 nm.

3. The optical film laminated body according to claim 1, wherein the reflective polarizing film is a uniaxially stretched multi-layered laminated film comprising 501 layers in total of first layers comprising a thermoplastic resin having a positive stress-optical coefficient and having a thickness of from 0.05 to 0.5 μm, and second layers comprising a thermoplastic resin and having a thickness of 0.05 to 0.5 μm, which are laminated alternately.

4. The optical film laminated body according to claim 3, wherein the reflective polarizing film comprises 501 layers in total of first layers comprising polyester having a melting point of from 260 to 270° C. and having a thickness of from 0.05 to 0.5 μm, and second layers comprising polyester having a melting point of from 210 to 255° C. and having a thickness of from 0.05 to 0.5 μm, which are laminated alternately, the melting point of the polyester of the second layers is lower than the melting point of the polyester of the first layers by from 15 to 60° C., and a ratio of a maximum thickness and a minimum thickness of the first layers and the second layers of the reflective polarizing film is from 1.5 to 5.0.

5. The optical film laminated body according to claim 1, wherein the optical film laminated body further comprises an adhesion facilitating layer between the reflective polarizing film and the absorptive polarizing film.

6. The optical film laminated body according to claim 5, wherein the adhesion facilitating layer contains a polymer component comprising from 55 to 85% by weight of co-polyester having a glass transition point of from 20 to 90° C. and from 15 to 45% by weight of polyvinyl alcohol having a saponification degree of from 80 to 90% by mol.

7. The optical film laminated body according to claim 6, wherein the co-polyester of the adhesion facilitating layer is a copolymer polyester containing a dicarboxylic acid component having a sulfonate salt group in an amount of from 1 to 16% by mol based on a total carboxylic acid component.

8. The optical film laminated body according to claim 6, wherein the adhesion facilitating layer further contains fine particles having an average particle diameter of from 20 to 80 nm in an amount of from 3 to 25 parts by weight and a crosslinking agent represented by the following formula (I) in an amount of from 5 to 20 parts by weight, per 100 parts by weight of the polymer component containing the co-polyester and the polyvinyl alcohol: 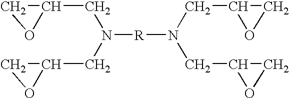
wherein R represents

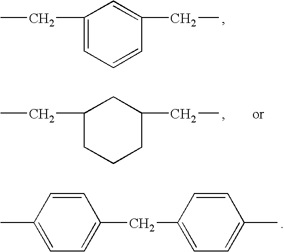

9. The optical film laminated body according to claim 1, wherein the transparent film is an optical compensation retardation film.

10. A liquid crystal display device comprising the optical film laminated body according to claim 1 and a liquid crystal cell, the optical film laminated body being disposed at least one surface of the liquid crystal cell.
